(19) United States
(12) Patent Application Publication
(10) Pub. No.: US 2020/0099683 A1
(43) Pub. Date: Mar. 26, 2020

(54) USER IDENTIFICATION AND AUTHENTICATION

(71) Applicant: salesforce.com, inc., San Francisco, CA (US)

(72) Inventors: Joshua ALEXANDER, San Francisco, CA (US); Seth HOLLOWAY, San Francisco, CA (US)

(73) Assignee: salesforce.com, inc., San Francisco, CA (US)

(21) Appl. No.: 16/140,293

(22) Filed: Sep. 24, 2018

(51) Int. Cl. H04L 29/06; G06F 21/36; G06F 21/45; G06F 21/60

(52) U.S. Cl. CPC H04L 63/0876; H04L 63/0853; H04L 63/102; H04L 63/1416; G06F 2221/2103; G06F 21/45; G06F 21/604; G06F 2221/2117; G06F 21/36

(57) ABSTRACT

Among other things, embodiments of the present disclosure may utilize identification information associated with a user from a variety of sources in order to authenticate the user for a particular platform. Other embodiments may be described and/or claimed.

### COPYRIGHT NOTICE

A portion of the disclosure of this patent document contains material which is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### TECHNICAL FIELD

Embodiments of the present disclosure relate to identifying and authenticating users attempting to establish electronic communications with computing devices. Other embodiments may be described and/or claimed.

### BACKGROUND

As the popularity of web-based services increases, users may have different account names, user names, and other identifying information associated with the user spread across multiple sites. Among other things, embodiments of the present disclosure may utilize identification information associated with a user from a variety of sources in order to authenticate the user for a particular platform.

### BRIEF DESCRIPTION OF THE DRAWINGS

The included drawings are for illustrative purposes and serve to provide examples of possible structures and operations for the disclosed inventive systems, apparatus, methods and computer-readable storage media. These drawings in no way limit any changes in form and detail that may be made by one skilled in the art without departing from the spirit and scope of the disclosed implementations.

FIG. 1A is a block diagram illustrating an example of an environment in which an on-demand database service can be used according to various embodiments of the present disclosure.

FIG. 1B is a block diagram illustrating examples of implementations of elements of FIG. 1A and examples of interconnections between these elements according to various embodiments of the present disclosure.

FIG. 2 is a flow diagram illustrating an example of a process according to various embodiments of the present disclosure.

### DETAILED DESCRIPTION

Examples of systems, apparatuses, computer-readable storage media, and methods according to the disclosed implementations are described in this section. These examples are being provided solely to add context and aid in the understanding of the disclosed implementations. It will thus be apparent to one skilled in the art that the disclosed implementations may be practiced without some or all of the specific details provided. In other instances, certain process or method operations, also referred to herein as “blocks,” have not been described in detail in order to avoid unnecessarily obscuring the disclosed implementations. Other implementations and applications also are possible, and as such, the following examples should not be taken as definitive or limiting either in scope or setting.

In the following detailed description, references are made to the accompanying drawings, which form a part of the description and in which are shown, by way of illustration, specific implementations. Although these disclosed implementations are described in sufficient detail to enable one skilled in the art to practice the implementations, it is to be understood that these examples are not limiting, such that other implementations may be used and changes may be made to the disclosed implementations without departing from their spirit and scope. For example, the blocks of the methods shown and described herein are not necessarily performed in the order indicated in some other implementations. Additionally, in some other implementations, the disclosed methods may include more or fewer blocks than are described. As another example, some blocks described herein as separate blocks may be combined in some other implementations. Conversely, what may be described herein as a single block may be implemented in multiple blocks in some other implementations. Additionally, the conjunction “or” is intended herein in the inclusive sense where appropriate unless otherwise indicated; that is, the phrase “A, B or C” is intended to include the possibilities of “A,” “B,” “C,” “A and B,” “B and C,” “A and C” and “A, B and C.”

Some implementations described and referenced herein are directed to systems, apparatuses, computer-implemented methods, and computer-readable storage media for identifying and authenticating users attempting to establish electronic communications with computing devices.

### I. SYSTEM EXAMPLES

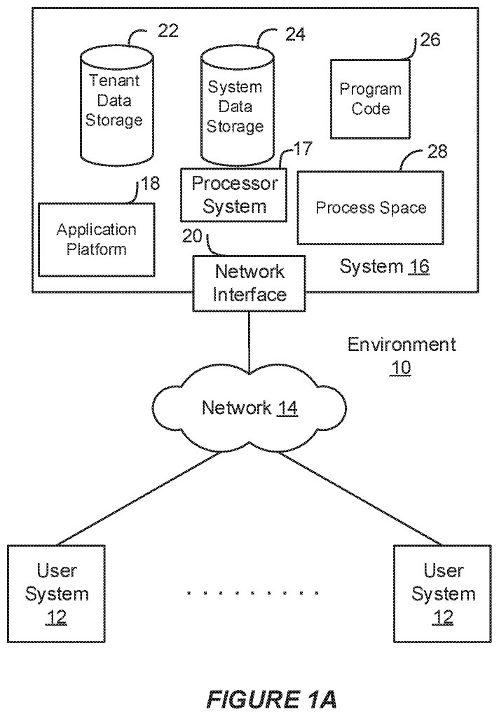

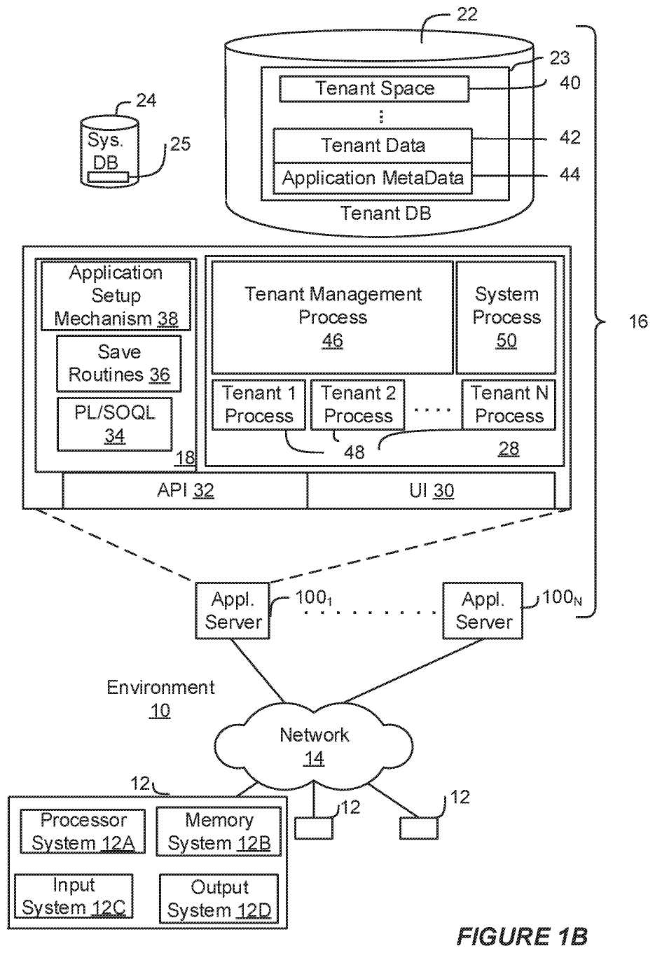

FIG. 1A shows a block diagram of an example of an environment 10 in which an on-demand database service can be used in accordance with some implementations. The environment 10 includes user systems 12, a network 14, a database system 16 (also referred to herein as a “cloud-based system”), a processor system 17, an application platform 18, a network interface 20, tenant database 22 for storing tenant data 23, system database 24 for storing system data 25, program code 26 for implementing various functions of the system 16, and process space 28 for executing database system processes and tenant-specific processes, such as running applications as part of an application hosting service. In some other implementations, environment 10 may not have all of these components or systems, or may have other components or systems instead of, or in addition to, those listed above.

In some implementations, the environment 10 is an environment in which an on-demand database service exists. An on-demand database service, such as that which can be implemented using the system 16, is a service that is made available to users outside of the enterprise(s) that own, maintain or provide access to the system 16. As described above, such users generally do not need to be concerned with building or maintaining the system 16. Instead, resources provided by the system 16 may be available for such users' use when the users need services provided by the system 16; that is, on the demand of the users. Some on-demand database services can store information from one or more tenants into tables of a common database image to form a multi-tenant database system (MTS). The term “multi-tenant database system” can refer to those systems in which various elements of hardware and software of a database system may be shared by one or more customers or tenants. For example, a given application server may simultaneously process requests for a great number of customers, and a given database table may store rows of data such as feed items for a potentially much greater number of customers. A database image can include one or more database objects. A relational database management system (RDBMS) or the equivalent can execute storage and retrieval of information against the database object(s).

Application platform 18 can be a framework that allows the applications of system 16 to execute, such as the hardware or software infrastructure of the system 16. In some implementations, the application platform 18 enables the creation, management and execution of one or more applications developed by the provider of the on-demand database service, users accessing the on-demand database service via user systems 12, or third party application developers accessing the on-demand database service via user systems 12.

In some implementations, the system 16 implements a web-based customer relationship management (CRM) system. For example, in some such implementations, the system 16 includes application servers configured to implement and execute CRM software applications as well as provide related data, code, forms, renderable web pages and documents and other information to and from user systems 12 and to store to, and retrieve from, a database system related data, objects, and Web page content. In some MTS implementations, data for multiple tenants may be stored in the same physical database object in tenant database 22. In some such implementations, tenant data is arranged in the storage medium(s) of tenant database 22 so that data of one tenant is kept logically separate from that of other tenants so that one tenant does not have access to another tenant's data, unless such data is expressly shared. The system 16 also implements applications other than, or in addition to, a CRM application. For example, the system 16 can provide tenant access to multiple hosted (standard and custom) applications, including a CRM application. User (or third party developer) applications, which may or may not include CRM, may be supported by the application platform 18. The application platform 18 manages the creation and storage of the applications into one or more database objects and the execution of the applications in one or more virtual machines in the process space of the system 16.

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (for example, in a server farm located in a single building or campus), or they may be distributed at locations remote from one another (for example, one or more servers located in city A and one or more servers located in city B). As used herein, each MTS could include one or more logically or physically connected servers distributed locally or across one or more geographic locations. Additionally, the term “server” is meant to refer to a computing device or system, including processing hardware and process space(s), an associated storage medium such as a memory device or database, and, in some instances, a database application (for example, OODBMS or RDBMS) as is well known in the art. It should also be understood that “server system” and “server” are often used interchangeably herein. Similarly, the database objects described herein can be implemented as part of a single database, a distributed database, a collection of distributed databases, a database with redundant online or offline backups or other redundancies, etc., and can include a distributed database or storage network and associated processing intelligence.

The network 14 can be or include any network or combination of networks of systems or devices that communicate with one another. For example, the network 14 can be or include any one or any combination of a LAN (local area network), WAN (wide area network), telephone network, wireless network, cellular network, point-to-point network, star network, token ring network, hub network, or other appropriate configuration. The network 14 can include a TCP/IP (Transfer Control Protocol and Internet Protocol) network, such as the global internetwork of networks often referred to as the “Internet” (with a capital “I”). The Internet will be used in many of the examples herein. However, it should be understood that the networks that the disclosed implementations can use are not so limited, although TCP/IP is a frequently implemented protocol.

The user systems 12 can communicate with system 16 using TCP/IP and, at a higher network level, other common Internet protocols to communicate, such as HTTP, FTP, AFS, WAP, etc. In an example where HTTP is used, each user system 12 can include an HTTP client commonly referred to as a “web browser” or simply a “browser” for sending and receiving HTTP signals to and from an HTTP server of the system 16. Such an HTTP server can be implemented as the sole network interface 20 between the system 16 and the network 14, but other techniques can be used in addition to or instead of these techniques. In some implementations, the network interface 20 between the system 16 and the network 14 includes load sharing functionality, such as round-robin HTTP request distributors to balance loads and distribute incoming HTTP requests evenly over a number of servers. In MTS implementations, each of the servers can have access to the MTS data; however, other alternative configurations may be used instead.

The user systems 12 can be implemented as any computing device(s) or other data processing apparatus or systems usable by users to access the database system 16. For example, any of user systems 12 can be a desktop computer, a work station, a laptop computer, a tablet computer, a handheld computing device, a mobile cellular phone (for example, a “smartphone”), or any other Wi-Fi-enabled device, wireless access protocol (WAP)-enabled device, or other computing device capable of interfacing directly or indirectly to the Internet or other network. The terms “user system” and “computing device” are used interchangeably herein with one another and with the term “computer.” As described above, each user system 12 typically executes an HTTP client, for example, a web browsing (or simply “browsing”) program, such as a web browser based on the WebKit platform, Microsoft's Internet Explorer browser, Apple's Safari, Google's Chrome, Opera's browser, or Mozilla's Firefox browser, or the like, allowing a user (for example, a subscriber of on-demand services provided by the system 16) of the user system 12 to access, process and view information, pages and applications available to it from the system 16 over the network 14.

Each user system 12 also typically includes one or more user input devices, such as a keyboard, a mouse, a trackball, a touch pad, a touch screen, a pen or stylus or the like, for interacting with a graphical user interface (GUI) provided by the browser on a display (for example, a monitor screen, liquid crystal display (LCD), light-emitting diode (LED) display, among other possibilities) of the user system 12 in conjunction with pages, forms, applications and other information provided by the system 16 or other systems or servers. For example, the user interface device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

The users of user systems 12 may differ in their respective capacities, and the capacity of a particular user system 12 can be entirely determined by permissions (permission levels) for the current user of such user system. For example, where a salesperson is using a particular user system 12 to interact with the system 16, that user system can have the capacities allotted to the salesperson. However, while an administrator is using that user system 12 to interact with the system 16, that user system can have the capacities allotted to that administrator. Where a hierarchical role model is used, users at one permission level can have access to applications, data, and database information accessible by a lower permission level user, but may not have access to certain applications, database information, and data accessible by a user at a higher permission level. Thus, different users generally will have different capabilities with regard to accessing and modifying application and database information, depending on the users' respective security or permission levels (also referred to as “authorizations”).

According to some implementations, each user system 12 and some or all of its components are operator-configurable using applications, such as a browser, including computer code executed using a central processing unit (CPU) such as an Intel Pentium® processor or the like. Similarly, the system 16 (and additional instances of an MTS, where more than one is present) and all of its components can be operator-configurable using application(s) including computer code to run using the processor system 17, which may be implemented to include a CPU, which may include an Intel Pentium® processor or the like, or multiple CPUs.

The system 16 includes tangible computer-readable media having non-transitory instructions stored thereon/in that are executable by or used to program a server or other computing system (or collection of such servers or computing systems) to perform some of the implementation of processes described herein. For example, computer program code 26 can implement instructions for operating and configuring the system 16 to intercommunicate and to process web pages, applications and other data and media content as described herein. In some implementations, the computer code 26 can be downloadable and stored on a hard disk, but the entire program code, or portions thereof, also can be stored in any other volatile or non-volatile memory medium or device as is well known, such as a ROM or RAM, or provided on any media capable of storing program code, such as any type of rotating media including floppy disks, optical discs, digital versatile disks (DVD), compact disks (CD), microdrives, and magneto-optical disks, and magnetic or optical cards, nanosystems (including molecular memory ICs), or any other type of computer-readable medium or device suitable for storing instructions or data. Additionally, the entire program code, or portions thereof, may be transmitted and downloaded from a software source over a transmission medium, for example, over the Internet, or from another server, as is well known, or transmitted over any other existing network connection as is well known (for example, extranet, VPN, LAN, etc.) using any communication medium and protocols (for example, TCP/IP, HTTP, HTTPS, Ethernet, etc.) as are well known. It will also be appreciated that computer code for the disclosed implementations can be realized in any programming language that can be executed on a server or other computing system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

FIG. 1B shows a block diagram with examples of implementations of elements of FIG. 1A and examples of interconnections between these elements according to some implementations. That is, FIG. 1B also illustrates environment 10, but FIG. 1B, various elements of the system 16 and various interconnections between such elements are shown with more specificity according to some more specific implementations. Additionally, in FIG. 1B, the user system 12 includes a processor system 12A, a memory system 12B, an input system 12C, and an output system 12D. The processor system 12A can include any suitable combination of one or more processors. The memory system 12B can include any suitable combination of one or more memory devices. The input system 12C can include any suitable combination of input devices, such as one or more touchscreen interfaces, keyboards, mice, trackballs, scanners, cameras, or interfaces to networks. The output system 12D can include any suitable combination of output devices, such as one or more display devices, printers, or interfaces to networks.

In FIG. 1B, the network interface 20 is implemented as a set of HTTP application servers 100₁-100_{N}. Each application server 100, also referred to herein as an “app server”, is configured to communicate with tenant database 22 and the tenant data 23 therein, as well as system database 24 and the system data 25 therein, to serve requests received from the user systems 12. The tenant data 23 can be divided into individual tenant storage spaces 40, which can be physically or logically arranged or divided. Within each tenant storage space 40, user storage 42 and application metadata 44 can similarly be allocated for each user. For example, a copy of a user's most recently used (MRU) items can be stored to user storage 42. Similarly, a copy of MRU items for an entire organization that is a tenant can be stored to tenant storage space 40.

The process space 28 includes system process space 102, individual tenant process spaces 48 and a tenant management process space 46. The application platform 18 includes an application setup mechanism 38 that supports application developers' creation and management of applications. Such applications and others can be saved as metadata into tenant database 22 by save routines 36 for execution by subscribers as one or more tenant process spaces 48 managed by tenant management process 46, for example. Invocations to such applications can be coded using PL/SOQL 34, which provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications can be detected by one or more system processes, which manage retrieving application metadata 44 for the subscriber making the invocation and executing the metadata as an application in a virtual machine.

The system 16 of FIG. 1B also includes a user interface (UI) 30 and an application programming interface (API) 32 to system 16 resident processes to users or developers at user systems 12. In some other implementations, the environment 10 may not have the same elements as those listed above or may have other elements instead of, or in addition to, those listed above.

Each application server 100 can be communicably coupled with tenant database 22 and system database 24, for example, having access to tenant data 23 and system data 25, respectively, via a different network connection. For example, one application server 100₁ can be coupled via the network 14 (for example, the Internet), another application server 100_{N-1} can be coupled via a direct network link, and another application server 100_{N} can be coupled by yet a different network connection. Transfer Control Protocol and Internet Protocol (TCP/IP) are examples of typical protocols that can be used for communicating between application servers 100 and the system 16. However, it will be apparent to one skilled in the art that other transport protocols can be used to optimize the system 16 depending on the network interconnections used.

In some implementations, each application server 100 is configured to handle requests for any user associated with any organization that is a tenant of the system 16. Because it can be desirable to be able to add and remove application servers 100 from the server pool at any time and for various reasons, in some implementations there is no server affinity for a user or organization to a specific application server 100. In some such implementations, an interface system implementing a load balancing function (for example, an F5 Big-IP load balancer) is communicably coupled between the application servers 100 and the user systems 12 to distribute requests to the application servers 100. In one implementation, the load balancer uses a least-connections algorithm to route user requests to the application servers 100. Other examples of load balancing algorithms, such as round robin and observed-response-time, also can be used. For example, in some instances, three consecutive requests from the same user could hit three different application servers 100, and three requests from different users could hit the same application server 100. In this manner, by way of example, system 16 can be a multi-tenant system in which system 16 handles storage of, and access to, different objects, data and applications across disparate users and organizations.

In one example of a storage use case, one tenant can be a company that employs a sales force where each salesperson uses system 16 to manage aspects of their sales. A user can maintain contact data, leads data, customer follow-up data, performance data, goals and progress data, etc., all applicable to that user's personal sales process (for example, in tenant database 22). In an example of an MTS arrangement, because all of the data and the applications to access, view, modify, report, transmit, calculate, etc., can be maintained and accessed by a user system 12 having little more than network access, the user can manage his or her sales efforts and cycles from any of many different user systems. For example, when a salesperson is visiting a customer and the customer has Internet access in their lobby, the salesperson can obtain critical updates regarding that customer while waiting for the customer to arrive in the lobby.

While each user's data can be stored separately from other users' data regardless of the employers of each user, some data can be organization-wide data shared or accessible by several users or all of the users for a given organization that is a tenant. Thus, there can be some data structures managed by system 16 that are allocated at the tenant level while other data structures can be managed at the user level. Because an MTS can support multiple tenants including possible competitors, the MTS can have security protocols that keep data, applications, and application use separate. Also, because many tenants may opt for access to an MTS rather than maintain their own system, redundancy, up-time, and backup are additional functions that can be implemented in the MTS. In addition to user-specific data and tenant-specific data, the system 16 also can maintain system level data usable by multiple tenants or other data. Such system level data can include industry reports, news, postings, and the like that are sharable among tenants.

In some implementations, the user systems 12 (which also can be client systems) communicate with the application servers 100 to request and update system-level and tenant-level data from the system 16. Such requests and updates can involve sending one or more queries to tenant database 22 or system database 24. The system 16 (for example, an application server 100 in the system 16) can automatically generate one or more SQL statements (for example, one or more SQL queries) designed to access the desired information. System database 24 can generate query plans to access the requested data from the database. The term “query plan” generally refers to one or more operations used to access information in a database system.

Each database can generally be viewed as a collection of objects, such as a set of logical tables, containing data fitted into predefined or customizable categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or element of a table can contain an instance of data for each category defined by the fields. For example, a CRM database can include a table that describes a customer with fields for basic contact information such as name, address, phone number, fax number, etc. Another table can describe a purchase order, including fields for information such as customer, product, sale price, date, etc. In some MTS implementations, standard entity tables can be provided for use by all tenants. For CRM database applications, such standard entities can include tables for case, account, contact, lead, and opportunity data objects, each containing pre-defined fields. As used herein, the term “entity” also may be used interchangeably with “object” and “table.”

In some MTS implementations, tenants are allowed to create and store custom objects, or may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In some implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

### II. USER IDENTIFICATION AND AUTHENTICATION

Among other things, embodiments of the present disclosure help provide a cohesive global identity experience by linking together bits of otherwise disparate data associated with a user to better identify and/or authenticate the user with respect to various computing platforms.

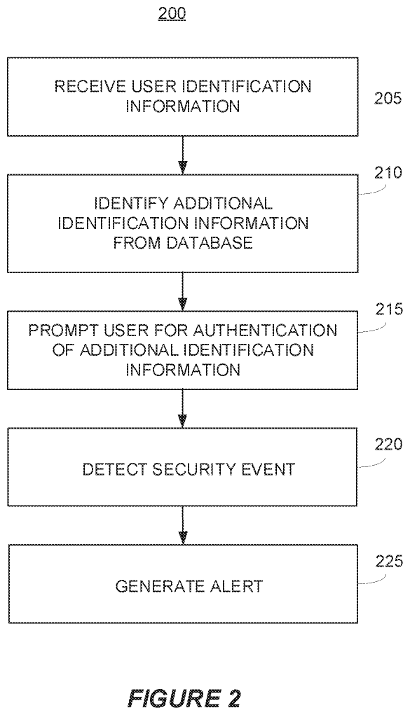

FIG. 2 is a flow diagram illustrating an example of a process 200 according to various aspects of the present disclosure. Any combination and/or subset of the elements of the methods depicted herein (including method 200 in FIG. 2) may be combined with each other, selectively performed or not performed based on various conditions, repeated any desired number of times, and practiced in any suitable order and in conjunction with any suitable system, device, and/or process. The methods described and depicted herein can be implemented in any suitable manner, such as through software operating on one or more computer systems. The software may comprise computer-readable instructions stored in a tangible computer-readable medium (such as the memory of a computer system) and can be executed by one or more processors to perform the methods of various embodiments.

In this example, process 200 includes receiving identification information associated with a user (205), identifying additional identification information associated with the user stored in a database (210), prompting the user to authenticate the additional information (215), detecting a security event (220), and generating an alert (225).

As described above, one or more user systems (e.g., user system 12 illustrated in FIGS. 1A and 1B), may attempt to establish electronic communications with a server computer system (e.g., implemented by system 16 illustrated in FIGS. 1A and 1B), such as over a network (e.g., network 14 in FIGS. 1A and 1B). In method 200, system 16 may receive the user identification information (205) in conjunction with establishing electronic communications. For example, a user may utilize a web browser operating on the user's computing device (e.g., user device 12 in FIG. 1A) to interface with a web site hosted by system 16.

A variety of identification information may be received (205) by systems of the present disclosure. In some embodiments, for example, the identification information associated with the user received from the user's client computing device may include: a user name, a password, an email address, a telephone number, or an authentication identifier (e.g., a unique identifier generated by the system for a user to reset a password or used in another authentication function).

Embodiments of the present disclosure may receive identifiers associated with a user's computing device. For example, the identification information associated with the user may include an Internet protocol (IP) address of the user's computing device, a media access control (MAC) address of the user's computing device, an identifier of a software application operating on the user's device, and other information.

The information provided by the user or the user's device may be used to identify additional information (215) having one more of the provided identifiers in common. For example, the identification information associated with the user received from the client computing device may include a first identifier (e.g., a first username) and a second identifier (e.g., an email address used to register the first username), and the additional information associated with the user identified in the database may include a third identifier (e.g., a second username) associated with the second identifier (e.g., the second username was registered using the same email address as the first username).

In some embodiments, a user may provide identification information (205) in conjunction with logging onto a webpage. In such cases, the system may analyze the provided identification information and search for additional information stored in a database in communication with the server computer system (such as databases 22 or 24 in FIG. 1A), where the additional information has a common association with one or more of the provided identifiers. In some embodiments, the system may prompt the user (e.g., via the user interface of the user's computing device) to authenticate the additional information associated with the user (215).

For example, the system may provide a list of one or more additional usernames associated with the user's provided information in a database, and prompt the user to verify whether the user is indeed associated with the alternate usernames. In this manner, the system can use the additional identification information to help authenticate a user even if the user never logged in from a particular browser, computer, and/or location before.

In some embodiments, the system may receive identification information (205) from a user registering for a new account or service. The system may identify an association between the user of the client computing device and a second user having a reputation rank. In some cases, the server computer system may generate an alert (225) associated with the user of the client computing device based on the reputation rank of the second user.

In this manner, embodiments of the present disclosure can help determine if the new registering user has any other known affiliations with either well-reputed users or poorly-reputed users. In addition to generating alerts (225) to help investigate the associations, the system may delay access by a user (and affiliated users) to the system until an alert is cleared (e.g., a human administrator reviews the alert and clears access by the user).

Similarly, the system may determine, based on the information provided from the user's computing device when creating/registering a new account, if the new registering user has any other known (i.e., existing) affiliations with the service. In this manner, the system can help reduce creation of “dummy” accounts (multiple accounts controlled by the same individual) on the system, as well as other potentially abusive actions.

Embodiments of the present disclosure may detect various security events (220), such as unauthorized system accesses or attempts. In response to a detected security event, the system may generate alerts (225) reporting the event, and identify associations between users of the system who may be involved in the event. For example, in response to a user of a client computing device providing information (e.g., while logging into the system), the system may identify a security event associated with a second user, and identify an association between the user of the client computing device and the second user.

In some cases, as noted above, a user's access to the system may be delayed or otherwise prevented until further action (e.g., independent investigation by a human administrator) is performed and the restriction removed. Identified users associated with security events may also be alerted to the security event and/or prompted to provide authentication information to verify their identification information was not misappropriated. Users associated with security events may also be automatically reported to other websites and organizations to help prevent similar security events on other platforms.

The specific details of the specific aspects of implementations disclosed herein may be combined in any suitable manner without departing from the spirit and scope of the disclosed implementations. However, other implementations may be directed to specific implementations relating to each individual aspect, or specific combinations of these individual aspects. Additionally, while the disclosed examples are often described herein with reference to an implementation in which an on-demand database service environment is implemented in a system having an application server providing a front end for an on-demand database service capable of supporting multiple tenants, the present implementations are not limited to multi-tenant databases or deployment on application servers. Implementations may be practiced using other database architectures, i.e., ORACLE®, DB2® by IBM and the like without departing from the scope of the implementations claimed.

It should also be understood that some of the disclosed implementations can be embodied in the form of various types of hardware, software, firmware, or combinations thereof, including in the form of control logic, and using such hardware or software in a modular or integrated manner. Other ways or methods are possible using hardware and a combination of hardware and software. Additionally, any of the software components or functions described in this application can be implemented as software code to be executed by one or more processors using any suitable computer language such as, for example, Java, C++ or Perl using, for example, existing or object-oriented techniques. The software code can be stored as a computer- or processor-executable instructions or commands on a physical non-transitory computer-readable medium. Examples of suitable media include random access memory (RAM), read only memory (ROM), magnetic media such as a hard-drive or a floppy disk, or an optical medium such as a compact disk (CD) or DVD (digital versatile disk), flash memory, and the like, or any combination of such storage or transmission devices. Computer-readable media encoded with the software/program code may be packaged with a compatible device or provided separately from other devices (for example, via Internet download). Any such computer-readable medium may reside on or within a single computing device or an entire computer system, and may be among other computer-readable media within a system or network. A computer system, or other computing device, may include a monitor, printer, or other suitable display for providing any of the results mentioned herein to a user.

While some implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. A server computer system comprising:
a processor; and
memory coupled to the processor and storing instructions that, when executed by the processor, cause the server computer system to perform operations comprising:
receiving, from a client computing device in communication with the server computer system, identification information associated with a user of the client computing device;
identifying, based on the received identification information, additional identification information associated with the user stored in a database in communication with the server computer system; and
causing the client computing device to prompt the user, via a user interface of the client computing device, to authenticate the additional identification information associated with the user.

2. The system of claim 1, wherein prompting the user to authenticate the additional identification information includes listing one or more additional user names identified as associated with the user.

3. The system of claim 1, wherein identifying the additional identification information includes identifying an association between the user of the client computing device and a second user having a reputation rank.

4. The system of claim 3, wherein the memory further stores instructions for causing the server computer system to generate an alert associated with the user of the client computing device based on the reputation rank of the second user.

5. The system of claim 1, wherein the identification information associated with the user is received from the client computing device in conjunction with a new account creation for the user on the system, and wherein identifying the additional identification information includes identifying an association between the user of the client computing device and an existing account on the system.

6. The system of claim 1, wherein the memory further stores instructions for causing the server computer system to detect a security event associated with the user.

7. The system of claim 6, wherein detecting the security event associated with the user of the client computing device includes:
identifying the security event associated with a second user; and
identifying an association between the user of the client computing device and the second user.

8. The system of claim 1, wherein the identification information associated with the user received from the client computing device includes: a user name, a password, an email address, a telephone number, or an authentication identifier.

9. The system of claim 1, wherein the identification information associated with the user received from the client computing device includes a first identifier and a second identifier, and the additional information associated with the user includes a third identifier associated with the second identifier.

10. A tangible, non-transitory computer-readable medium storing instructions that, when executed by a server computer system, cause the server computer system to perform operations comprising:
receiving, from a client computing device in communication with the server computer system, identification information associated with a user of the client computing device;
identifying, based on the received identification information, additional identification information associated with the user stored in a database in communication with the server computer system; and
causing the client computing device to prompt the user, via a user interface of the client computing device, to authenticate the additional identification information associated with the user.

11. The computer-readable medium of claim 10, wherein prompting the user to authenticate the additional identification information includes listing one or more additional user names identified as associated with the user.

12. The computer-readable medium of claim 10, wherein identifying the additional identification information includes identifying an association between the user of the client computing device and a second user having a reputation rank.

13. The computer-readable medium of claim 12, wherein the medium further stores instructions for causing the server computer system to generate an alert associated with the user of the client computing device based on the reputation rank of the second user.

14. The computer-readable medium of claim 10, wherein the identification information associated with the user is received from the client computing device in conjunction with a new account creation for the user on the system, and wherein identifying the additional identification information includes identifying an association between the user of the client computing device and an existing account on the system.

15. The computer-readable medium of claim 10, wherein the medium further stores instructions for causing the server computer system to detect a security event associated with the user.

16. The computer-readable medium of claim 15, wherein detecting the security event associated with the user of the client computing device includes:
identifying the security event associated with a second user; and
identifying an association between the user of the client computing device and the second user.

17. The computer-readable medium of claim 10, wherein the identification information associated with the user received from the client computing device includes: a user name, a password, an email address, a telephone number, or an authentication identifier.

18. The computer-readable medium of claim 10, wherein the identification information associated with the user received from the client computing device includes a first identifier and a second identifier, and the additional information associated with the user includes a third identifier associated with the second identifier.

19. A method comprising:
receiving, from a client computing device in communication with the server computer system, identification information associated with a user of the client computing device;
identifying, based on the received identification information, additional identification information associated with the user stored in a database in communication with the server computer system; and
causing the client computing device to prompt the user, via a user interface of the client computing device, to authenticate the additional identification information associated with the user.

20. The method of claim 19, wherein the identification information associated with the user received from the client computing device includes a first identifier and a second identifier, and the additional information associated with the user includes a third identifier associated with the second identifier.
